(19) United States
(12) Patent Application Publication
(10) Pub. No.: US 2020/0050071 A1
(43) Pub. Date: Feb. 13, 2020

(54) ELECTROCHROMIC DEVICES

(71) Applicants: Liping MA, San Diego, CA (US); NITTO DENKO CORPORATION, Osaka (JP)

(72) Inventor: Liping Ma, San Diego, CA (US)

(21) Appl. No.: 16/485,619

(22) PCT Filed: Feb. 14, 2018
(86) PCT No.: PCT/US2018/018242

§ 371 Date: Aug. 13, 2019

Related U.S. Application Data
(60) Provisional application No. 62/458,926, filed on Feb. 14, 2017.
(60) Provisional application No. 62/545,092, filed on Aug. 14, 2017.

(51) Int. Cl. G02F 1/1514; G02F 1/155; G02F 1/153

(52) U.S. Cl. CPC G02F 1/1514; G02F 1/155; G02F 2001/1536; G02F 2001/15145; G02F 1/1533

(57) ABSTRACT

The present disclosure relates to electrochromic devices including an electrochromic material having one or more optical properties that may be changed upon application of an electric potential. In one exemplary electrochromic device, a first layer includes at least one electrode, a second layer provides a tunneling dielectric channel, a third layer includes an electrochromic material, a fourth layer is electrically insulative, and a fifth layer includes at least one electrode. Upon provision of an electric potential above a threshold where electron tunneling may occur in the second layer, electrons may be passed to or from the electrochromic material through the second layer resulting in a change to the one or more optical properties of the electrochromic material. An opposite electric potential may be provided to reverse the change in the one or more optical properties.

### CROSS-REFERENCE TO RELATED APPLICATIONS

This application claims the benefit of U.S. Provisional Patent Application Nos. 62/458,926 filed Feb. 14, 2017 and 62/545,092, filed Aug. 14, 2017, the contents of which are incorporated herein by reference in their entireties.

### BACKGROUND

The present disclosure generally relates to electrochromic devices which include an electrochromic material having one or more optical properties that may be changed upon application of an electric potential. More particularly, but not exclusively, the present disclosure relates to an electrochromic device exhibiting insulative properties intended for retaining changes to the one or more optical properties following application of the electric potential.

Electrochromic coatings or materials may be used for a number of different purposes, including, for example, in controlling the amount of light and/or heat passing through a window based on a user-controlled electrical potential that is applied across an optical stack of the electrochromic coating. The control provided by the electrochromic coating or material can reduce the amount of energy necessary to heat or cool a room, and it may provide privacy. For example, a clear state of the electrochromic coating or material having an optical transmission of about 60-80% can be switched to a darkened state having an optical transmission of between 0.1-10% where the energy flow into the room is limited and additional privacy is provided. Due to large amounts of glass found in various types of windows, such as skylights, aircraft windows, residential and commercial building windows, and automobile windows, there may be energy savings provided by the use of an electrochromic coating or material on this glass (see e.g., Solar Energy Materials and Solar Cells, (1994) pp. 307-321).

Despite the potential benefits which may be provided by an electrochromic coating or device, various issues may make current electrochromic devices undesirable for certain applications. For example, for electrochromic devices which utilize an electrolyte, low ion mobility of the electrolyte may cause reductions in switching speeds and temperature-dependence issues. Ion intercalation may also occur in the electrochromic layer of the device which causes the device volume to expand, and resultant mechanical stresses may limit the ability to operate between on and off cycles of the device. In this regard, there is a trade-off between high-speed switching and uniform switching because high ion mobility gives a very low internal device resistance for a larger area device, and this may lead to non-uniformity in application of an electric field across the whole device area. Also, some electrochromic devices need continuous application of electrical power in order to retain changes to the one or more optical properties of the electrochromic material caused by application of the electric potential. Thus, there remains a need for further contributions in this area of technology.

The subject matter disclosed and claimed herein is not limited to embodiments that solve any disadvantages or that operate only in environments such as those described above. Rather, this background is only provided to illustrate examples of where the present disclosure may be utilized.

### SUMMARY

The present disclosure generally relates to electrochromic devices which include an electrochromic material having one or more optical properties that may be changed upon application of an electric potential. More particularly, but not exclusively, the present disclosure relates to an electrochromic device exhibiting insulative properties intended for retaining changes to the one or more optical properties of the electrochromic material following application of the electric potential.

In one embodiment, an electrochromic device includes a first layer including at least one electrode, a second layer providing a tunneling dielectric channel, a third layer including an electrochromic material, an electrically insulative fourth layer, and a fifth layer including at least one electrode.

In another embodiment, a system includes an electrochromic device including an electrochromic material. At least one optical property of the electrochromic material may be changed from a first state to a second state upon application of an electric potential. Further, the device is structured to maintain the at least one optical property of the electrochromic material in the second state without continued application of the electric potential.

In yet another embodiment, a method for operating an electrochromic device including an electrochromic material includes supplying an electric potential to the device to change at least one optical property of the electrochromic material from a first state to a second state. The method also includes discontinuing supply of the electric potential while maintaining the at least one optical property of the electrochromic material in the second state.

This Summary introduces a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims.

### BRIEF DESCRIPTION OF THE DRAWINGS

FIG. 1 is a schematic illustration of one embodiment of an electrochromic device.

FIG. 2 is a schematic illustration of an alternative embodiment of an electrochromic device.

FIG. 3A is a perspective view of a window including an electrochromic device.

FIG. 3B is a sectional view of the window of FIG. 3A taken along view lines IIIB of FIG. 3A.

FIGS. 4-6 are schematic illustrations of non-limiting operation principles of the electrochromic devices illustrated in FIGS. 1 and 2.

FIG. 7 is a schematic illustration of the electrochromic device of Example EC-1.

FIG. 8 is a graphic illustration showing the relative reflectance (%) as a function of wavelength (nm) of the device of Example EC-1 in an ON state and OFF state.

FIG. 9 is a graphic illustration showing the relative reflectance (%) as a function of wavelength (nm) of the device of Example EC-1C in an ON state and OFF state.

FIG. 10 is a graphic illustration showing the relative reflectance (%) over time (seconds) of the devices of Examples EC-1 and EC-1C in an ON state (retention time).

FIG. 11 is a graphic illustration showing the relative reflectance (%) as a function of wavelength (nm) of the devices of Examples EC-1 and EC-1C in an OFF state (retention time).

FIG. 12 is a graphic illustration showing the relative reflectance (%) over time (seconds) of the device of Example EC-1 during an ON and OFF pulse cycling.

FIG. 13 is a schematic illustration of the electrochromic device of Example EC1-B.

FIG. 14 is a graphic illustration showing the relative reflectance (%) as a function of wavelength (nm) of the device of Example EC1-B in an ON state and OFF state.

FIG. 15 is a graphic illustration showing the relative reflectance (%) over time (seconds) of the device of Example EC1-B in an ON state (retention time).

FIG. 16 is a schematic illustration of the electrochromic device of Example EC1-C.

FIG. 17 is a graphic illustration showing the relative reflectance (%) as a function of wavelength (nm) of the device of Example EC1-C in an ON state and OFF state.

FIG. 18 is a graphic illustration showing the relative reflectance (%) over time (seconds) of the device of Example EC1-C in an ON state (retention time).

FIG. 19 is a schematic illustration of the electrochromic device of Example EC1-D.

FIG. 20 is a graphic illustration showing the relative reflectance (%) as a function of wavelength (nm) the device of Example EC1-D in an ON state and OFF state.

FIG. 21 is a schematic illustration of the electrochromic device of Example EC1-E.

FIG. 22 is a graphic illustration showing the relative reflectance (%) as a function of wavelength (nm) of the device of Example EC1-E in an ON state and OFF state.

FIG. 23 is a graphic illustration showing the relative reflectance (%) over time (seconds) of the device of Example EC1-E during an ON and OFF pulse cycling.

FIG. 24 is a schematic illustration of the electrochromic device of Example EC1-F.

FIG. 25 is a graphic illustration showing the relative reflectance (%) over time (seconds) of the device of Example EC1-F with and without a tunneling layer in an ON state (retention time).

FIG. 26 is a graphic illustration showing the relative reflectance (%) over time (seconds) of the device of Example EC1-F with and without a tunneling layer in an OFF state (retention time).

FIG. 27 is a schematic illustration of the electrochromic device of Example EC1-G.

FIG. 28 is a graphic illustration showing the relative reflectance (%) as a function of wavelength (nm) of the device of Example EC1-G in an ON state and OFF state.

FIG. 29 is a graphic illustration showing the relative reflectance (%) over time (seconds) of the device of Example EC1-G during an ON (5 volts applied) and OFF (−2 volts applied) pulse cycling.

FIG. 30 is a schematic illustration of the electrochromic device of Example EC-2A.

FIG. 31 is a graphic illustration showing the relative reflectance (%) as a function of wavelength (nm) of the device of Example EC-2A in an ON state and OFF state.

FIG. 32 is a schematic illustration of the electrochromic device of Example EC-2B.

FIG. 33 is a graphic illustration showing the relative reflectance (%) as a function of wavelength (nm) of the device of Example EC-2B in an ON state and OFF state.

FIG. 34 is a schematic illustration of the electrochromic device of Example EC-2C.

FIG. 35 is a graphic illustration showing the transmittance (%) as a function of wavelength (nm) of the device of Example EC-2C in an ON state and OFF state.

FIG. 36 is a schematic illustration of the electrochromic device of Example EC-2D.

FIG. 37 is a graphic illustration showing the transmittance (%) as a function of wavelength (nm) of the device of Example EC-2D in an ON state and OFF state.

FIG. 38 is a schematic illustration of the electrochromic device of Example EC-2E.

FIG. 39 is a graphic illustration showing the transmittance (%) as a function of wavelength (nm) of the device of Example EC-2E in an ON state and OFF state.

FIG. 40 is a graphic illustration showing the transmittance (%) as a function of wavelength (nm) of the device of Example EC-2E with varying ON voltages (5 to 18 volts).

FIG. 41 is a schematic illustration of the electrochromic device of Example EC-3B.

FIG. 42 is a graphic illustration showing the relative reflectance (%) as a function of wavelength (nm) of the device of Example EC-3B in an ON state and OFF state.

FIG. 43 is a graphic illustration showing the transmittance (%) as a function of wavelength (nm) of the device of Example EC-3B in an ON state and OFF state.

FIG. 44 is a schematic illustration of the electrochromic device of Example EC-3C.

FIG. 45 is a graphic illustration showing the relative reflectance (%) as a function of wavelength (nm) of the device of Example EC-3C in an ON state and OFF state.

FIG. 46 is a graphic illustration showing the relative reflectance (%) as a function of time (seconds) of the device of Example EC-3C in an ON state and OFF state.

FIG. 47 is a schematic illustration of the electrochromic device of Example EC-3D.

FIG. 48 is a graphic illustration showing the relative reflectance (%) as a function of wavelength (nm) of the device of Example EC-3D in an ON state and OFF state.

FIG. 49 is a schematic illustration of the electrochromic device of Example EC-3E.

FIG. 50 is a graphic illustration showing the relative reflectance (%) as a function of wavelength (nm) of the device of Example EC-3E in an ON state and OFF state.

FIG. 51 is a graphic illustration showing the relative reflectance (%) over time (seconds) of the device of Example EC-3E during an ON (5 volts applied) and OFF (−2 volts applied) pulse cycling.

FIG. 52 is a schematic illustration of the electrochromic device of Example EC-3F.

FIG. 53 is a graphic illustration showing the relative reflectance (%) over time (seconds) of the device of Example EC-3F with or without a tunneling layer in an ON state.

FIG. 54 is a graphic illustration showing the relative reflectance (%) over time (seconds) of the device of Example EC-3F with or without a tunneling layer during an OFF state.

FIG. 55 is a schematic illustration of the electrochromic device of Example EC-3G.

FIG. 56 is a graphic illustration showing the relative reflectance (%) as a function of wavelengths (nm) of the device of Example EC-3G in an ON and OFF state.

FIG. 57 is a graphic illustration showing the relative reflectance (%) over time (seconds) of the device of Example EC-3G during an ON (5 volts applied) and OFF (−2 volts applied) pulse cycling.

FIG. 58 is a schematic illustration of a system for testing electrochromic devices disclosed herein.

### DETAILED DESCRIPTION

For purposes of promoting an understanding of the present disclosure, reference will now be made to the following embodiments and specific language will be used to describe the same. It will nevertheless be understood that no limitation of the scope of the disclosure is thereby intended, such alterations and further modifications in the described subject matter, and such further applications of the disclosed principles as described herein being contemplated as would normally occur to one skilled in the art to which the disclosure relates.

The present disclosure generally relates to electrochromic devices which include an electrochromic material having one or more optical properties that may be changed upon application of an electric potential. More particularly, but not exclusively, the present disclosure relates to an electrochromic device exhibiting insulative properties intended for retaining changes to the one or more optical properties of the electrochromic material following application of the electric potential.

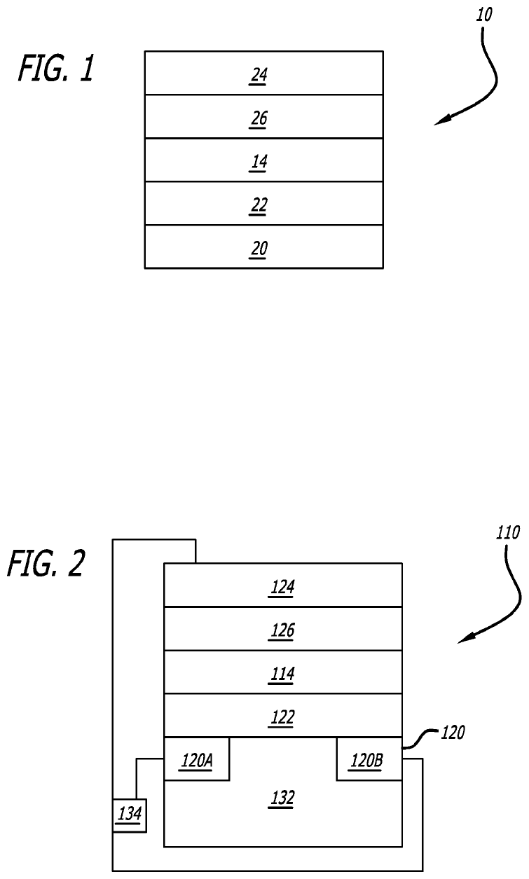

Referring now to FIG. 1, there is schematically illustrated an electrochromic device 10 which includes a layer 14 including an electrochromic material. Positioned on a first side of layer 14, device 10 also includes a layer 20 with at least one electrode and a layer 22 that provides a tunneling dielectric channel. On an opposite, second side of layer 14, device 10 includes a layer 24 with at least one electrode and a layer 26 that includes an electrically insulative material. Also, while not illustrated, it should also be appreciated that device 10 may include a buffer layer positioned between layers 24, 26.

In the illustrated form, the at least one electrode of layer 20 is electrically isolated or separated from the electrochromic material of layer 14 by layer 22, which provides a tunneling dielectric channel. In one form, the electrical isolation or separation between these layers may result from increased resistivity within layer 22. Further, the at least one electrode of layer 24 is also electrically isolated or separated from the electrochromic material of layer 14 by layer 26, which includes an electrically insulative material. In one form, the electrical isolation or separation between these layers may result from increased resistivity within layer 26. In addition, it should be appreciated that layer 20 is in electrical communication with layer 22, which is in electrical communication with layer 14, which is in electrical communication with layer 26, which is in electrical communication with layer 24.

One or more optical properties of the electrochromic material of layer 14 may be changed when an electric potential is provided between electrodes 20, 24 of device 10. However, as will be described in greater detail below, the change in optical property(ies) of the electrochromic material will not occur until the electric potential reaches a threshold. At the threshold, electron tunneling may occur in layer 22 in order to permit passage of electrons through layer 22 to or from the electrochromic material and/or passage of electrons through layer 26 to or from the electrochromic material may occur. In this respect, layer 14 and the electrochromic material thereof may be described as being in selective electrical communication with the at least one electrode of layer 20 by virtue of the insulative effect (which may be overcome) of layer 22. Also, the at least one electrode of layer 24 may also be described as being in selective electrical communication with layer 14 and the electrochromic material thereof due to the insulative properties of layer 26 which may be overcome upon application of a sufficient electric potential. While not previously mentioned, it should be appreciated that other arrangements of the elements of device 10 are possible. For example, in one form, layer 22 which provides the tunneling dielectric channel may be positioned between the top electrode (electrode of layer 24) and layer 14 including the electrochromic material, and layer 26 may be positioned between layer 14 and the bottom electrode (electrode of layer 20). In this latter instance, the buffer layer (if present) may be positioned between layer 26 and the bottom electrode.

Turning now to FIG. 2, there is schematically illustrated an alternative electrochromic device 110. Similar to device 10, device 110 includes a layer 114 including an electrochromic material. Device 110 also includes a layer 120 with a first electrode 120A and a second electrode 120B. Layer 120 and electrodes 120A, 120B thereof are positioned on a substrate 132. Layer 122 is positioned between layer 120 and layer 114 and provides a tunneling dielectric channel similar to layer 22. Device 110 also includes a layer 124 with at least one electrode and a layer 126 that includes an electrically insulative material and is positioned between layer 124 and layer 114. In the illustrated form, layers 120, 122 are positioned on a first side of layer 114 and layers 124, 126 are positioned on an opposite, second side of layer 114. Also, while not illustrated, it should also be appreciated that device 110 may include a buffer layer positioned between layers 124, 126.

In the illustrated form, electrodes 120A, 120B of layer 120 are electrically isolated or separated from the electrochromic material of layer 114 by layer 122, which provides a tunneling dielectric channel. In one form, the electrical isolation or separation between these elements may result from increased resistivity within layer 122. Further, the at least one electrode of layer 124 is also electrically isolated or separated from the electrochromic material of layer 114 by layer 126 which includes an electrically insulative material. In one form, the electrical isolation or separation between these elements may result from increased resistivity within layer 126. In addition, it should be appreciated that layer 120 is in electrical communication with layer 122, which is in electrical communication with layer 114, which is in electrical communication with layer 126, which is in electrical communication with layer 124.

For reasons similar to those discussed above with respect to device 10, layer 114 may be described as being in selective electrical communication with electrodes 120A, 120B by virtue of the insulative effect (which may be overcome) of layer 122. Also, the at least one electrode of layer 124 may also be described as being in selective electrical communication with layer 114 and the electrochromic material thereof due to the insulative properties of layer 126 which may be overcome upon application of a sufficient electric potential.

While not previously mentioned, it should be appreciated that other arrangements of the elements of device 110 are possible. For example, in one form, the position of substrate 132 may not change, i.e., it remains on the bottom of the device, but layer 122 which provides the tunneling dielectric channel may be positioned between the top electrode (the electrode(s) of layer 124) and layer 114 including the electrochromic material, and layer 126 may be positioned between layer 114 and the bottom electrode (the electrode(s) of layer 120). In this latter instance, the buffer layer (if present) may be positioned between layer 126 and the bottom electrode.

A power source 134 is also illustrated in FIG. 2, and electrodes 120A, 120B and the at least one electrode of layer 124 may be electrically coupled to or in electrical communication with power source 134. As will be described in greater detail below, power source 134 may be used to selectively provide an electric potential such as a voltage pulse to electrodes 120A, 120B and/or the at least one electrode of layer 124 to effect desired passage of electrons through layer 122 or layer 126 to or from the electrochromic material of layer 114. Also, while not previously described, it should be understood that the at least one electrode of layer 124 may be a gate electrode, electrode 120A may be a source electrode, and 120B may be a drain electrode. In one form, it is contemplated that layer 122 may be disposed between the source and drain electrodes or layer 122 may bridge the source and drain electrodes. Also, in the illustrated, form electrodes 120A and 120B are separated by substrate 132; however, alternative configurations are contemplated.

As indicated above, layers 22, 122 provide a tunneling dielectric channel. In one form, layers 22, 122 may include one or more electrically insulative materials, including inorganic and/or organic materials which exhibit electrically insulative properties. In one or more forms, as suggested above, upon the application of a suitable electric potential, such as a voltage pulse, to the electrodes of layers 20 and 24 of device 10 (FIG. 1), or between the electrode of layer 124 (such as a control-gate electrode) and electrode 120A as a source electrode (FIG. 2), band bending may occur in layers 22, 122 in order to pass electrons to or from layers 14, 114 which are being charged to or discharged from the electrochromic material in order to alter at least one optical property, such as transmittance, of the electrochromic material. In one form, layers 22, 122 may be formed in whole or in part by oxide and/or nitride compounds, such as, for example, aluminum oxide, tantalum oxide, yttrium oxide, calcium oxide, magnesium oxide and/or zirconium oxide, Si₃N₄, and AlN. In one form, layers 22, 122 include aluminum oxide or tantalum oxide. In one form, layers 22, 122 may be a stoichiometric metal oxide layer, such as Al₂O₃, Ta₂O₅, Y₂O₃, CaO, MgO or ZrO₂, but non-stoichiometric metal oxide layers for layers 22, 122 are also contemplated. Layers 22, 122 can have a thickness in the range of about 0.1 nm to about 50 nm, about 0.01 nm to about 20 nm, about 0.01 nm to about 10 nm, about 0.1 nm to about 5 nm, about 0.1 nm to about 4 nm, about 0.1 nm to about 3 nm, about 0.1 nm to about 2 nm, about 0.1 nm to about 1 nm, or about 0.1 nm to about 0.5 nm, about 1 nm to about 2 nm, about 2 nm to about 3 nm, about 3 nm to about 4 nm, about 4 nm to about 5 nm, about 5 nm to about 10 nm, about 10 nm to about 15 nm, about 15 nm to about 20 nm, or any thickness in a range bounded by any of these values, although other variations are contemplated. In one form, layers 22, 122 have a thickness which is greater than the thickness of layers 14, 114. In one form, the material(s) forming layers 22, 122 and/or the structure of layers 22, 122 are effective for impeding or entirely blocking, on a selective basis, electrons from moving through layers 22, 122. In this form, layers 22, 122 may be effective for maintaining (in whole or in part) charges injected in or discharged from the electrochromic materials of layers 14, 114 to be stored under a no bias condition; i.e., without continued application of an electric potential.

Turning now to layers 26, 126, these layers may include one or more materials which exhibit electrically insulative properties, and these materials may be the same as those included in layers 22, 122. Similarly, layers 26, 126 may include inorganic and/or organic materials which exhibit electrically insulative properties. In one form, layers 26, 126 may be formed in whole or in part by oxide and/or nitride compounds, such as, for example, aluminum oxide, tantalum oxide, yttrium oxide, calcium oxide, magnesium oxide and/or zirconium oxide, Si₃N₄, and AlN. In one form, layers 26, 126 include aluminum oxide or tantalum oxide. In one form, layers 26, 126 may be a stoichiometric metal oxide layer, such as Al₂O₃, Ta₂O₅, Y₂O₃, CaO, MgO or ZrO₂, but non-stoichiometric metal oxide layers for layers 26, 126 are also contemplated. In one form, layers 26, 126 include a plurality of different electrically insulative materials which are arranged in a layered fashion within layers 26, 126.

In one form, the material(s) forming layers 26, 126 and/or the structure of layers 26, 126 are effective for entirely blocking, on a selective basis, electrons from moving through layers 26, 126. In this form, layers 26, 126 may be effective for maintaining (in whole or in part) charges injected in or discharged from the electrochromic materials of layers 14, 114 to be stored under a no bias condition; i.e., without continued application of an electric potential. In some embodiments, layers 26, 126 have a thickness which is greater than the thickness of layers 22, 122, although variations in which the thickness of layers 26, 126 is the same or less than the thickness of layers 22, 122 are contemplated. In one non-limiting form, layers 26, 126 have a thickness which is greater than about 4 nm, such as about 4-200 nm, about 40-120 nm, about 20-40 nm, about 40-60 nm, about 50 nm, about 60-80 nm, about 80-100 nm, about 100 nm, about 100-120 nm, about 120-150 nm, about 170 nm, or about 150-200 nm, or any thickness in a range bounded by any of these values, although other values for the thickness of layers 26, 126 are contemplated. In one form, layers 26, 126 may provide an insulative effect which is greater than the insulative effect provided by layers 22, 122. However, in other forms, the insulative effect provided by layers 26, 126 may be the same or less than the insulative effect provided by layers 22, 122.

Layers 20, 24 and 120, 124 may be defined in their entirety by the electrode(s) found in these layers, or it is possible that the electrodes of these layers only partially define these layers. In one form, the electrodes of these layers may be formed on a bonding layer and/or substrate. One or more of these electrodes, and the remainder of layers 20, 24, 120, 124 where the electrodes only partially define these layers, may be formed of a transparent material. As used herein, the term “transparent” means a property in which the corresponding material transmits or passes light. In one aspect, the transmittance of light through the transparent material may be greater than or equal to 50% and less than or equal to 100%. When one or more of the electrodes and layers 20, 24, 120, 124 are transparent, light can be efficiently taken in from the outside of layers 14, 114 to interact with the electrochromic material of these layers which enables reflection of optical characteristics of the electrochromic material on emitted light. While not previously noted, it should be understood that the term “light” as used herein means light in a wavelength region targeted by the electrochromic material. For example, when the electrochromic material is used as a filter of an image pickup apparatus for a visible light region, light in the visible light region is targeted, and when the electrochromic material is used as a filter of an image pickup apparatus for an infrared region, light in the infrared region is targeted.

When transparent, the electrodes may be obtained by forming a conductive layer of, for example, a transparent conductive oxide or dispersed carbon nanotubes on a transparent substrate, partly arranging metal wires on a transparent substrate, or combinations thereof. In one form, the electrodes may be formed from a transparent conductive oxide material having good transmissivity and conductivity, such as tin-doped indium oxide (ITO), zinc oxide, gallium-doped zinc oxide (GZO), indium zinc oxide (IZO), aluminum-doped zinc oxide (AZO), tin oxide, antimony-doped tin oxide (ATO), fluorine-doped tin oxide (FTO), and niobium-doped titanium oxide (TNO), a conductive polymer material, or a material containing Ag, Ag nanoparticles, carbon nanotubes or graphene. Of the transparent conductive oxide materials identified above, FTO may be selected for heat resistance, reduction resistance, and conductivity, and ITO may be selected for conductivity and transparency. In the event a porous electrode is formed and calcined, then the transparent conductive oxide if used preferably has high heat resistance. One or more of the electrodes may contain one of these materials, or one or more of the electrodes may have a multi-layer structure containing a plurality of these materials. In an alternative form, one or more of the electrodes may be formed from a reflective material such as a Group 10 of 11 metal, non-limiting examples of which include Au, Ag, and/or Pt. Forms in which the reflective material is a Group 13 metal, such as aluminum (Al) are also possible.

As indicated above, in some forms, devices 10, 110 may include a buffer layer which is positioned between layer 26, 126 and layer 24, 124 or between layer 20, 120 and layer 26, 126. In one form where the buffer layer is present, it may include a bisphenyl pyridine compound such as a 3,5 diphenyl pyridine. In one form, the bisphenyl pyridine compound may include the bisphenyl pyridine compounds described in U.S. Pat. No. 9,051,284, which is incorporated by reference in its entirety for its description of bisphenyl pyridine compounds. In one particular but non-limiting form, the bisphenyl pyridine has the following structure:

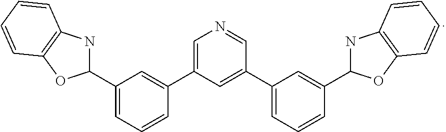 [SMILES: c1cc(-c2cncc(-c3cccc(C4Nc5ccccc5O4)c3)c2)cc(C2Nc3ccccc3O2)c1]

Additionally or alternatively, the buffer layer may also include a covalent material such as a metal oxide. One specific but non-limiting example of a suitable metal oxide is Al₂O₃. In some forms, when the buffer layer is a metal oxide, the layer can have a thickness between about 0.1 nm, 0.3 nm, 2 nm, 3 nm, to about 5 nm, about 0.1-2 nm, about 2-4 nm, about 4-6 nm, about 6-10 nm, and/or any combination of the aforementioned thicknesses. Still, in other forms, the buffer layer can be from about 0.1 nm to about 20 nm thick.

As indicated above, layer 14, 114 includes an electrochromic material. In one form, the electrochromic material may include an electrochromic compound and a matrix material. In one particular but non-limiting form, the electrochromic material includes a metal oxide such as WO₃. However, it should be appreciated that layer 14, 114 can include any electrochromic material or compound that changes optical transmittance and/or absorption when, for example, it is in a charged-state that can be achieved by, for example, the charged injection from the electrode(s) of layer 20, 120 through layer 22, 122 into layer 14, 114 under an applied voltage pulse above a critical value where electron tunneling occurs.

Additionally or alternatively, the electrochromic material can include charge sensitive materials that may be effected by localized plasma resonant. In some forms, the electrochromic material may include both inorganic and/or organic materials. When an organic compound is included, it may be a low-molecular weight organic compound and/or a high-molecular weight organic compound. Each of these types of materials may be colored by the application of an electric potential as described herein. Non-limiting examples of high-molecular weight organic compounds of this type include those containing a pyridinium salt, and the compound can be, for example, a viologen-based high-molecular weight compound. In some embodiments, the electrochromic material can include a low-molecular weight organic compound. The electrochromic material may also include a compound that undergoes changes in optical properties, such as from a decolored form to a colored form, through an oxidation reaction (i.e., by giving up electrons) or a reduction reaction (i.e., by accepting electrons). In one or more forms, the electrochromic material includes one or more anodic electrochromic materials and/or one or more cathodic electrochromic materials.

The term “anodic electrochromic material” as used herein means a material that undergoes changes in optical properties by an oxidation reaction thereof in which electrons are removed from the material. In contrast, the term “cathodic electrochromic material” as used herein means a material that undergoes changes in optical properties by a reduction reaction thereof in which electrons are given to the material.

Non-limiting examples of anodic electrochromic materials include thiophene derivatives, an amine having an aromatic ring (such as a phenazine derivative and a triallylamine derivative), a pyrrole derivative, a thiazine derivative, a triallylmethane derivative, a bisphenylmethane derivative, a xanthene derivative, a fluoran derivative, and a spiropyran derivative. Of the foregoing examples, as the anodic electrochromic materials, low-molecular weight thiophene derivatives (such as a monothiophene derivative, an oligothiophene derivative, and a thienoacene derivative) and low-molecular weight amines each having an aromatic ring (such as a phenazine derivative and a triallylamine derivative) can be used.

While not wanting to be limited by theory, it is believed that the use of those molecules in the electrochromic material may facilitate the provision of an electrochromic element having a desired absorption wavelength profile. These molecules have an absorption peak in the ultraviolet region in a neutral state, do not exhibit absorption in the visible light region, and are in a decolored state having a high transmittance in the visible light region. Through an oxidation reaction, these molecules are converted into radical cations to shift the absorption to the visible light region, resulting in a colored state. The absorption wavelength of any such molecule and the potential at which the redox reaction progresses can be designed by increasing or decreasing the π-conjugation length thereof, or changing a substituent thereof to change the π-conjugated system thereof.

As used herein, the term “low-molecular weight” refers to a compound having a molecular weight of 2,000 or less. In one form, the low-molecular weight compound has a molecular weight of 1,000 or less. A cathodic electrochromic material includes, for example, a pyridine-based compound, such as a viologen derivative, or a quinone compound. The absorption wavelength of any such molecule and the potential at which the redox reaction thereof progresses can be designed by increasing or decreasing the π-conjugation length thereof, or changing a substituent thereof to change the it-conjugated system thereof.

Layer 14, 114 including the electrochromic material may have any suitable thickness, such as about 50-500 nm, about 100-300 nm, about 200-400 nm, about 300-500 nm, or any thickness in a range bounded by any of these values, although other variations are contemplated.

Layer 14, 114 including the electrochromic material may be fixed to layer 26, 126, layer 22, 122, layer 20, 120 and/or layer 24, 124. The different options for fixing layer 14, 114 are possible because in this layer, at the time of the adjustment of charge imbalance, charge exchange between the electrodes needs only to occur, and there is no need to cause the electrochromic material to diffuse through an electrolyte to reach the source, drain or gate electrodes. In addition, as described above, in devices where electrolytes are present and the electrochromic material can freely diffuse through the electrolyte, it may cause the transformation of a colored form into a decolored form as the material reaches an electrode. In these instances, a feature for reducing substance transportation, such as a partition wall, could be used for suppressing the transformation. In contrast, when the electrochromic material may be fixed to the electrodes, or presented in a form without the presence of electrolytes, there may be a reduced likelihood of the transformation of the colored form into the decolored form.

Non-limiting methods of fixing layer 14, 114 including the electrochromic material involves, for example, bonding the electrochromic material to an insulating material through a functional group in a molecule of the electrochromic material, causing an insulating material to retain the electrochromic material in a comprehensive manner (e.g., in a film state) through the utilization of a force, such as an electrostatic interaction, or causing the electrochromic material to physically adsorb to an insulative material. A method involving chemically bonding a low-molecular weight organic compound serving as the electrochromic material to a porous insulative material through a functional group thereof, or a method involving forming a high-molecular weight compound serving as the electrochromic material on the insulative material may be used when a quick reaction of the electrochromic material is desired. The former method may include fixing the low-molecular weight organic compound serving as the electrochromic material onto a fine particle oxide electrode, such as aluminum oxide, titanium oxide, zinc oxide, or tin oxide, through a functional group, such as an acid group (e.g., a phosphoric acid group or a carboxylic acid group). The latter method is, for example, a method involving polymerizing and forming a viologen polymer on an insulative and/or tunneling dielectric material and may include electrolytic polymerization.

It is contemplated that device 10 or 110 could be used for a number of different purposes and applications. In one non-limiting form for example, devices 10, 110 could be used in a window member that includes a pair of transparent substrates with device 10, 110 positioned between the transparent substrates. Through use of device 10 or 110, the window member can adjust the quantity of light which may be transmitted through the transparent substrates. In addition, the window member can include a frame which supports device 10 or 110, and the window member can be used in an aircraft, an automobile, a house, or the like, just to provide a few possibilities.

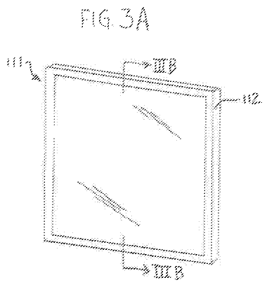

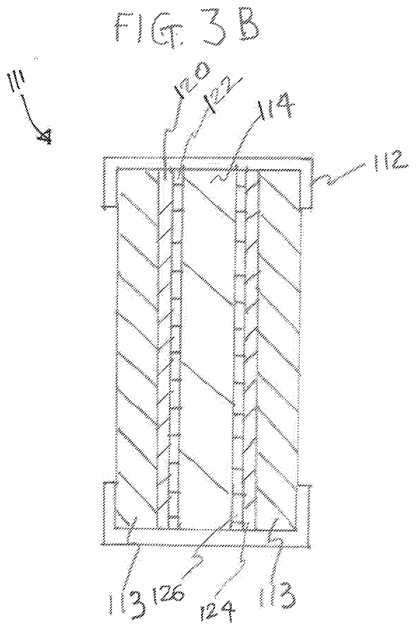

Turning now more specifically to FIGS. 3A and 3B, window member 111 functions as a light control window, and includes device 110 (provided that electrode 120B is not shown), transparent plates 113 configured to sandwich and support device 110, and a frame 112 configured to surround the entirety thereof to integrate device 110 and plates 113. Layers 120, 122, 124, 126 may be integrated in frame 112, or may be connected to layer 114 through a wiring arranged outside of frame 112.

In window member 111 of FIGS. 3A and 3B, transparent plates 113 are not particularly limited as long as plates 113 are formed from materials having a high light transmittance. In one form for example, plates 113 are formed of glass. In window member 111, device 110 and the elements thereof are constituent members independent of transparent plates 113 but, for example, the elements of device 110 may be used to resemble transparent plates 113. While not previously discussed, it should be appreciated that a number of different materials may be suitable for frame 112, and any structure that covers and/or supports at least a portion of device 110 may serve as frame 112.

While not intended to be limited to any theory or method of operability, further details regarding operation of the electrochromic devices disclosed herein will now be provided. Regarding device 110 for example, it includes source electrode 120A, drain electrode 120B and a control gate such as a gate electrode in layer 124. The control gate or gate electrode is isolated from, but capacitively coupled to, layer 114. Activation of or turning on the electrochromic material of layer 114 may involve, for example, charging layer 114 with electrons. Due to the presence of layer 122 and/or layer 126, the activation or turn-on threshold of the electrochromic material of layer 114 is increased relative to forms where these layers are absent. Thus, with the presence of layers 122 and 126, the electrochromic material will not be activated or turned on until the electric potential applied reaches a certain threshold. Stated alternatively, the electrochromic material of layer 114 will be activated or turned on at a significantly or distinguishably higher threshold of the electric potential. As such, the electrochromic material of layer 114 will generally remain non-conductive (or detectably less conductive) when addressed with an “on” potential applied to the control gate/gate electrode. Deactivating or turning the electrochromic material off may, for example, involve removing electrons from the electrochromic material of layer 114 to lower the threshold to a base state, which may be considered analogous to the binary “0” in non-volatile memory device operation. With the lower threshold, device 110 may be activated or turned on to a fully conductive state when addressed with an “on” potential to the control gate/gate electrode.

Activation of or turning on the electrochromic material of layer 114 may be accomplished through hot electron injection or Fowler-Nordheim (F-N) tunneling by establishing a large positive voltage between the gate electrode and the source electrode, and a positive voltage between the drain electrode and the source electrode. The act of discharging the electrochromic material (which may be considered analogous to a floating gate) may be known as the off step and may be accomplished generally through Fowler-Nordheim tunneling between the gate electrode and the source electrode (source erase) or between the gate electrode and the substrate (channel erase). Source erasing may be performed by supplying a positive bias to the source electrode while the gate electrode is grounded or negatively biased. Channel erasing may be performed by supplying a negative bias to the gate electrode and/or a positive bias to the substrate.

In one form, activation of or turning on the electrochromic material of layer 114 involves injecting electrons into layer 114 as both the source and the drain electrodes are held at a ground potential and a positive voltage is applied to the control gate/gate electrode. In various embodiments, the positive voltage (Vpp) may be from about 1 to about 5 volts, at least 12 volts when the positive read or operating voltage, Vdd, is about 5 volts, and from about 20 volts to about 25 volts, although other variations are contemplated. In order to deactivate or turn off the electrochromic material of layer 114, both the source and the drain electrodes can be held at a ground potential, and a negative voltage is applied to the control gate/gate electrode, or both the source and the drain electrodes can be held at a ground potential and a positive voltage is applied to the gate electrode. In various embodiments, the negative voltage (Vpp) may be, for example at least −1 volt, −2 volts, −4 volts, −5 volts, up to −12 volts (e.g., when the negative read or operating voltage (Vdd) is about −2 volts), or from about −20 volts to about −25 volts. A ground potential generally refers to a virtual ground potential or a voltage level of about 0V. Programming is believed to be effected by conventional electron injection. Alternatively, holes may be stored on the electrochromic material of layer 114 by supplying a negative voltage (e.g., −Vpp) to the control gate/gate electrode. In a further alternative embodiment, a reference cell, “unprogrammed” transistor, or transistor storing a “0” binary logic state may be programmed to a complementary binary logic state using a bias opposite to that of the programmed cell(s), leading to a greater delta Vₜ between the programmed-unprogrammed cell pairs (e.g., the complementary binary logic states). The greater threshold voltage difference enhances the margin over which the devices are functional, increases data retention time, and/or allows read operations under less stringent (e.g., subthreshold swing) conditions.

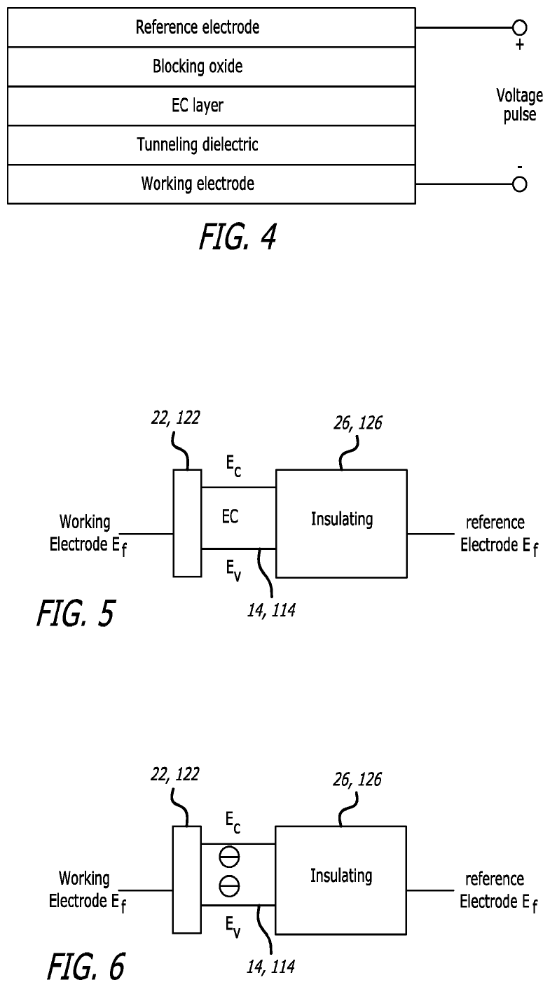

While operation has been described in connection with device 110, it is believed that the operating principles of device 110 and 10 are the same. Moreover, further details regarding operating principles of these devices will be described in connection with FIGS. 4-6. In FIG. 4, a voltage pulse is applied to the second electrode (identified in FIG. 4 as the reference electrode) and the first electrode (identified in FIG. 4 as the working electrode). Since the device is insulated under normal operation, the applied voltage pulse is only needed for switching states of the electrochromic material of layer 14, 114. Further, as indicated above, electron tunneling may only occur upon application of a critical voltage pulse necessary to push electrons into or out of the electrochromic material of layer 14, 114. Moreover, given that the device is insulated under normal operation and the electrochromic material of layer 14, 114 is insulated from the electrodes, the leakage of charges into or out of the electrochromic material is reduced, minimized, or eliminated.

The tunneling dielectric channel provided by layer 22, 122 and the insulating effect of layer 26, 126 may provide a wide band gap insulating effect, while layer 14, 114, which could be a semiconductor, has a lower-level conduction band that can keep the electron[s] trapped therein as the “memory” effect (non-volatile), which reduces, minimizes and/or insures no power consumption under normal device operation unless a switching process is occurring. Similarly, this arrangement can reduce, minimize and/or eliminate the issue of leakage suffered in other forms of electrochromic devices. In addition, the insulative properties of the devices described herein allow the voltage applied from the power supply to the electrochromic material of layer 14, 114 to be uniformly applied without potential drop to the electrode since the resistance of the device is much larger than the resistance of the electrode. Other forms of electrochromic devices may generally be highly conductive and in applications for a larger area such as a window, the device has a much lower resistance and the electrode layer's resistance can be comparable to or less than the device's resistance. This may result in a drop across the electrode layer which may cause non-uniformity in application of the power supply for applications of these devices in larger area applications. In contrast, as indicated above, it is believed the devices described herein may be effective for minimizing, reducing or eliminating the occurrence of this issue.

Referring now to FIG. 5, illustrated therein is the band structure of various embodiments described herein, where the electrochromic material of layer 14, 114 can trap both electrons and holes. When a voltage pulse is supplied to the two electrodes above a critical value, the band bending at layer 22, 122, which is thinner than layer 26, 126, will cause electron injection from the working electrode into the electrochromic material of layer 14, 114. The charges will be stored in the electrochromic material of layer 14, 114 due to the insulative effect provided by layers 22, 122 and 26, 126. The stored charges in the electrochromic material of layer 14, 114 may cause a color change or a change in transmission/absorption. For example, it may cause a change from a former clear-state to a high absorption-state (FIG. 6).

In one form, activation of or turning on the electrochromic material of layer 14, 114 may involve supplying a first positive voltage to the control gate/gate electrode, supplying a second positive voltage to the drain electrode, and holding the source electrode at a ground potential. In one form, the first and second positive voltages are conventional read voltages (e.g., Vdd) less than Vpp, and may generally be from about 1.5 to 9V, or any range of values therein.

Deactivation of or turning off the electrochromic material of layer 14, 114 involves the inverse of the activation/turning on procedure. For example, if the electrochromic material of layer 14, 114 is activated/turned on by supplying a positive voltage to the control gate/gate electrode, the deactivation/turning off operation involves supplying a negative voltage of about the same magnitude to the control gate/gate electrode while the source electrode and drain electrode are held at a ground potential. Alternatively, if the electrochromic material of layer 14, 114 is activated by supplying a negative voltage to the control gate/gate electrode, the deactivation/turning off operation involves supplying a positive voltage of about the same magnitude to the control gate/gate electrode while the source electrode and drain electrode are held at a ground potential.

### EXAMPLES

It should be appreciated that the following Examples are for illustration purposes and are not intended to be construed as limiting the subject matter disclosed in this document to only the embodiments disclosed in these examples.

An electrochromic device (Example EC-1) was prepared according to the following process. A glass substrate was prepared by cutting a 1.1 mm thick glass substrate to a 5 cm×5 cm size. The glass substrate was then washed with detergent and DI water, rinsed with fresh DI water and sonicated for about 1 hour. The glass substrate was then soaked in isopropanol (IPA) and sonicated for about 1 hour. The glass substrate was then soaked in acetone and sonicated for about 1 hour. The glass substrate was then removed from the acetone bath and dried with nitrogen gas at room temperature. The glass substrate was then loaded into a vacuum deposition chamber (Angstrom Engineering, Inc.) set at 2×10′ torr and a described deposition rate. First, 20 nm thick metallic ITO films were deposited at O₂ pressure (PO₂) of 10⁻⁵ torr as the transparent source and drain electrodes or as a single electrode disposed upon the substrate. Then, an Al₂O₃ buffer layer was deposited under vacuum of 10⁻⁷ torr, where the deposition rate of an Al₂O₃ (3 nm) film was about 2 Angstroms/second for the remaining layers. A LiF blocking or insulating layer (100 nm) was deposited upon the Al₂O₃ film at a deposition rate of about 2 angstrom/second. A WO₃ thin film (electrochromic material/layer) as described in U.S. Pat. No. 8,610,992 was deposited on the Al₂O₃ film. An Al₂O₃ tunneling layer of 3 nm was deposited upon the electrochromic material/layer. An Al layer film was deposited as the gate electrode on the tunneling layer. Electrical connections were connected between a power source (Tektronix, Inc., Beaverton, Oreg., USA, Kethley 2400 sourcemeter) and switched electrical connections with the first (drain) electrode, second (source) electrode and/or third (control gate) electrode to enable selective application of potential to the drain and control gate electrode (on) or to the drain and source electrodes (off).

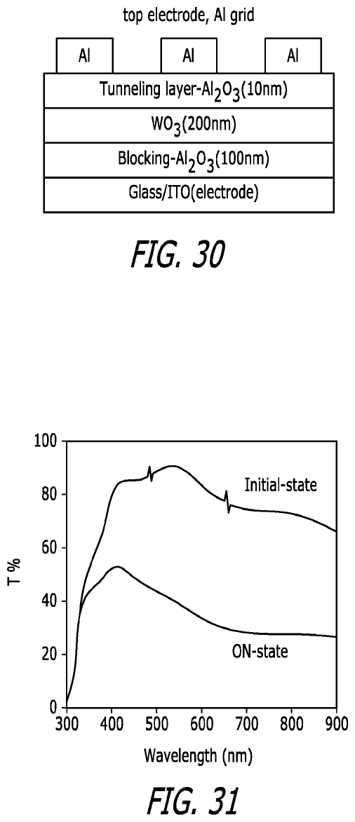

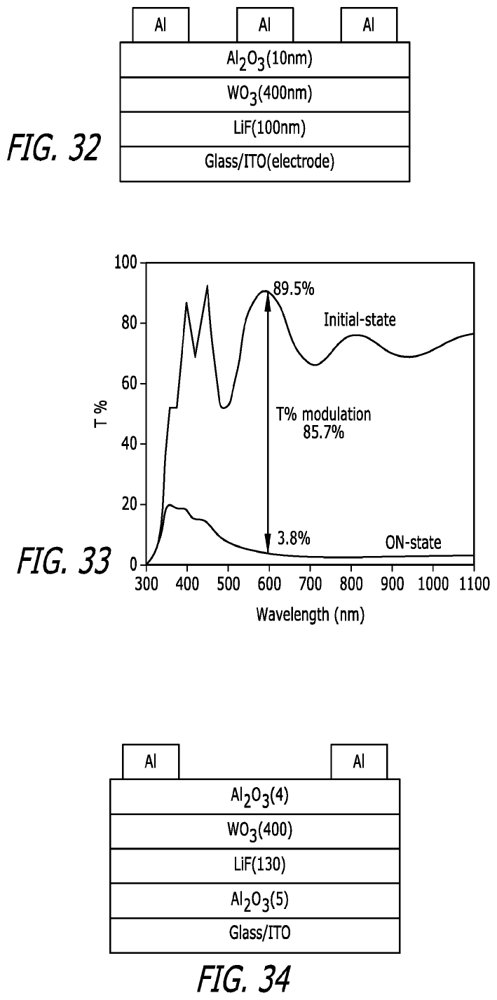

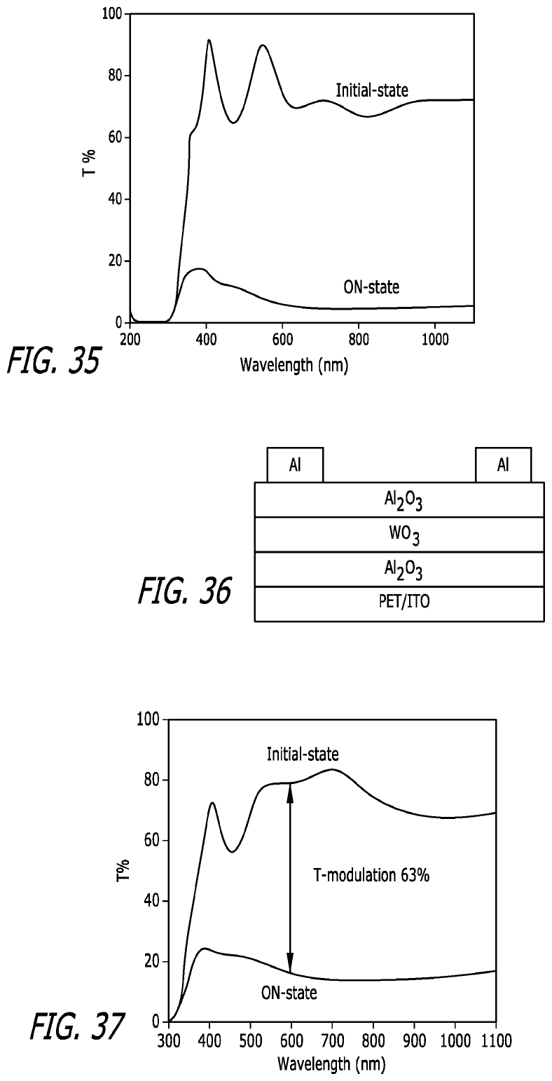

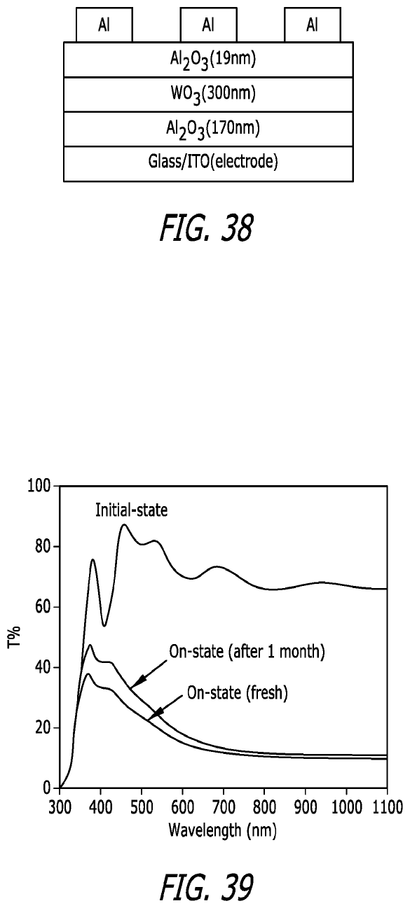

The devices of Examples EC-1C, EC1-B through EC1-G, EC-2A through EC-2E, and EC-3B through EC-3G were made in a manner similar to that described above with respect to the device of Example EC-1, except as indicated in TABLE 1 below. To the extent needed for the examples associated with FIGS. 30-40, aluminum grid lines were created upon the tunneling layer (instead of an aluminum vapor deposited layer) by masking, vapor deposition and removal of the mask (Al grid line of about 1-2 mm with a gap of about 10 mm between adjacent grid lines).

TABLE 1

| | | | | | Electro- | | |
|---|---|---|---|---|---|---|---|
| | | | Buffer | Blocking | chromic | Tunneling | |
| Example | Substrate | Electrode | layer | layer | layer | layer | Electrode |
| EC-1 | Glass | ITO | Al₂O₃ | LiF | WO₃ | Al₂O₃ | Al |
| | | | (3 nm) | (100 nm) | (300 nm) | (0.3 nm) | (200 nm) |
| EC-1C | Glass | ITO | Al₂O₃ | LiF | WO₃ | None | Al |
| | | | (3 nm) | (100 nm) | (300 nm) | | (200 nm) |
| EC1-B | Glass | ITO | BC-1 | LiF | WO₃ | Al₂O₃ | Al |
| | | | (2 nm) | (100 nm) | (300 nm) | (3 nm) | (200 nm) |
| EC1-C | Glass | ITO | BC-1 | Al₂O₃ | WO₃ | Al₂O₃ | Al |
| | | | (2 nm) | (100 nm) | (400 nm) | (2 nm) | (200 nm) |
| EC1-D | Glass | ITO | None | Al₂O₃ | WO₃ | Al₂O₃ | Al |
| | | | | (100 nm) | (400 nm) | (2 nm) | (200 nm) |
| EC1-E | Glass | ITO | BC-1 | Al₂O₃ | WO₃ | None | Al |
| | | (120 nm) | (3 nm) | (50 nm) | (300 nm) | | (100 nm) |
| | | | | & LiF | | | |
| | | | | (50 nm) | | | |
| EC1-F | Glass | ITO | BC-1 | Al₂O₃ | WO₃ | Al₂O₃ | Al |
| | | (120 nm) | (3 nm) | (50 nm) | (300 nm) | (0.3 nm) | (100 nm) |
| | | | | & LiF | | | |
| | | | | (50 nm) | | | |
| EC1-G | Glass | ITO | BC-1 | Al₂O₃ | WO₃ | Al₂O₃ | Al |
| | | (120 nm) | (3 nm) | (50 nm) | (200 nm) | (2 nm) | (100 nm) |
| | | | | & LiF | | | |
| | | | | (50 nm) | | | |
| EC-2A | Glass | ITO | None | Al₂O₃ | WO₃ | Al₂O₃ | Al grid |
| | | | | (100 nm) | (200 nm) | (10 nm) | line (1-2 |
| | | | | | | | mm, gap |
| | | | | | | | 10 mm) |
| EC-2B | Glass | ITO | None | LiF | WO₃ | Al₂O₃ | Al grid |
| | | | | (100 nm) | (400 nm) | (10 nm) | line (1-2 |
| | | | | | | | mm, gap |
| | | | | | | | 10 mm) |
| EC-2C | Glass | ITO | Al₂O₃ | LiF | WO₃ | Al₂O₃ | Al grid |
| | | | (5 nm) | (130 nm) | (400 nm) | (4 nm) | line (1-2 |
| | | | | | | | mm, gap |
| | | | | | | | 10 mm) |
| EC-2D | PET | ITO | None | Al₂O₃ | WO₃ | Al₂O₃ | Al grid |
| | | | | (100 nm) | (400 nm) | (4 nm) | line (1-2 |
| | | | | | | | mm, gap |
| | | | | | | | 10 mm) |
| EC-2E | Glass | ITO | None | Al₂O₃ | WO₃ | Al₂O₃ | Al grid |
| | | | | (170 nm) | (300 nm) | (19 nm) | line (1-2 |
| | | | | | | | mm, gap |
| | | | | | | | 10 mm) |
| EC-3B | Glass | ITO | BC-1 | LiF | WO₃ | Al₂O₃ | Al |
| | | | (2 nm) | (100 nm) | (300 nm) | (3.0 nm) | (200 nm) |
| EC-3C | Glass | ITO | BC-1 | Al₂O₃ | WO₃ | Al₂O₃ | Al |
| | | | (2 nm) | (100 nm) | (400 nm) | (2.0 nm) | (200 nm) |
| EC-3D | Glass | ITO | None | Al₂O₃ | WO₃ | Al₂O₃ | Al |
| | | | | (100 nm) | (400 nm) | (2.0 nm) | (200 nm) |
| EC-3E | Glass | ITO | BC-1 | Al₂O₃ | WO₃ | Al₂O₃ | Al |
| | | (120 nm) | (3 nm) | (100 nm) | (400 nm) | (2.0 nm) | (200 nm) |
| EC-3F | Glass | ITO | BC-1 | Al₂O₃ | WO₃ | Al₂O₃ | Al |
| | | (120 nm) | (3 nm) | (50 nm) | (300 nm) | (0.3 nm) | (100 nm) |
| | | | | & LiF | | | |
| | | | | (50 nm) | | | |
| EC-3G | Glass | ITO | BC-1 | Al₂O₃ | WO₃ | Al₂O₃ | Al |
| | | (120 nm) | (3 nm) | (50 nm) | (200 nm) | (2.0 nm) | (100 nm) |
| | | | | & LiF | | | |
| | | | | (50 nm) | | | |

### Absolute Reflectance (R %)

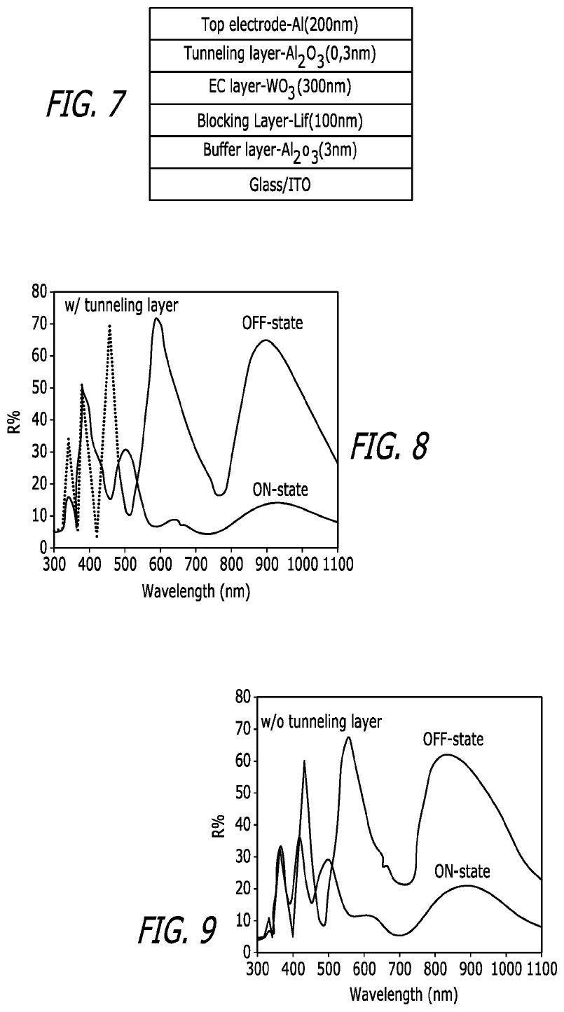

The Example EC-1 device (FIG. 7) with a tunneling layer described herein was positioned onto a Filmetrics F10-RT-YV reflectometer (Filmetrics, San Diego, Calif., USA), and the absolute reflectance (R %) was determined over varying wavelengths of light. The results are shown in FIG. 8. Absolute reflectance (R %) of the Example EC-1C device without a tunneling layer as described herein was tested in the same manner. The results are shown in FIG. 9.

### Relative Reflectance (Relative Reflectance, 0 to 1.0)

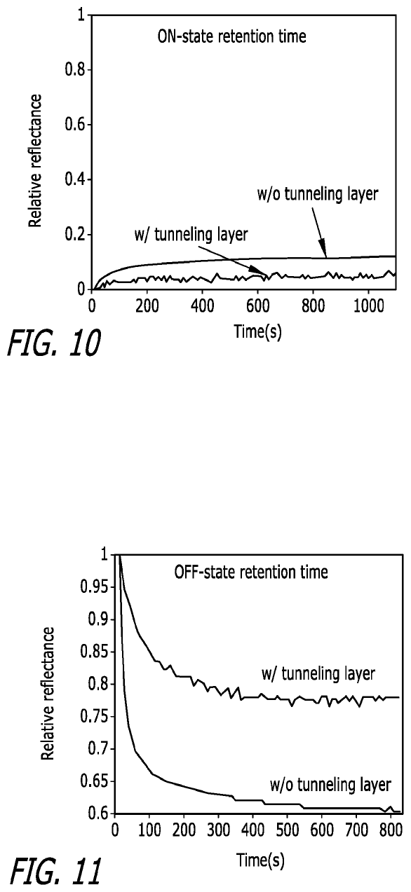

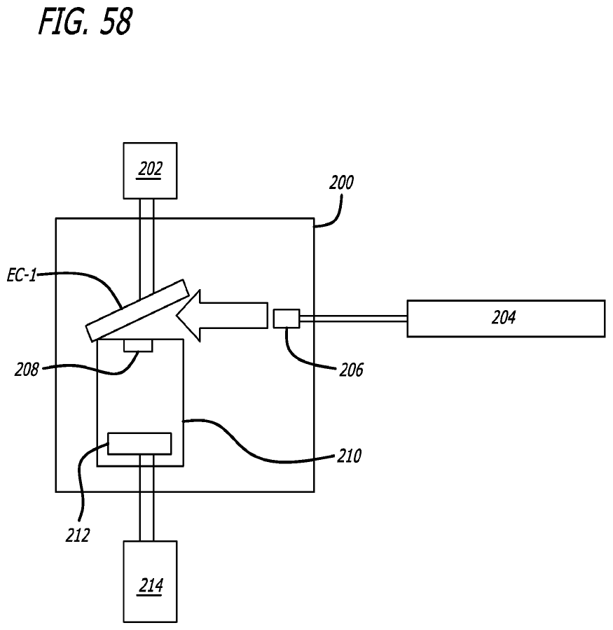

The Example EC-1 device (with the tunneling layer) and the Example EC-1C device (without the tunneling layer) were individually positioned in a testing device 200, as shown in FIG. 58, at an angle of about 15 degrees. About 5 volts from a power source 202 was applied to the Example EC-1 device to activate it to an ON-state and then about −2 volts was applied to the Example EC-1 device to deactivate it to an OFF-state. 2.8/2.9 volts DC (10 mA) was applied by a Protek 3003B power source 204 to a LED white light source 206, and the light generated therefrom impinged upon the angled Example EC-1 device to reflect into an opening 208 at the first end of a second enclosure 210 to impinge upon a Si-photo diode 212 disposed at the opposite enclosed end of the second enclosure. The Si-photo diode was connected to a personal computer 214 to determine reflectance relativity; e.g., raw data was generated, including the photocurrent generated by the photosensor in nA and time, and the generated photocurrent from the photosensor while in the OFF state was subtracted from the ON state and the curves were normalized by dividing the amounts by the determined OFF-state maximum. The results are shown in FIGS. 10 and 11 and Table 2 below.

TABLE 2

| Tunneling layer thickness | OFF-state (after 850 s) | ON-state (after 1100 s) |
|---|---|---|
| (nm) | remains | Remains |
| 0 | 60.2% | 87.6% |
| 3 | 78.1% | 93.6% |

Based on these results, it can be seen that the decay is lower for the device with the tunneling layer. It can also be seen that, for the device with the tunneling layer, there is a longer retention time and the color state is retained longer.

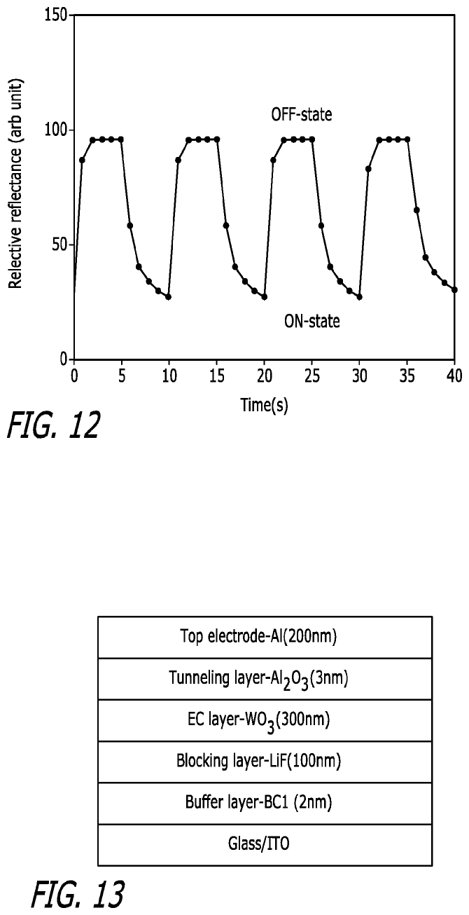

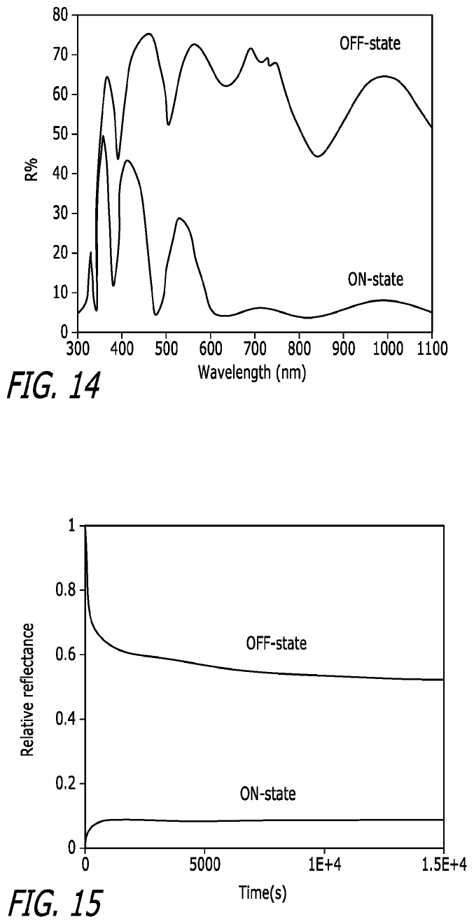

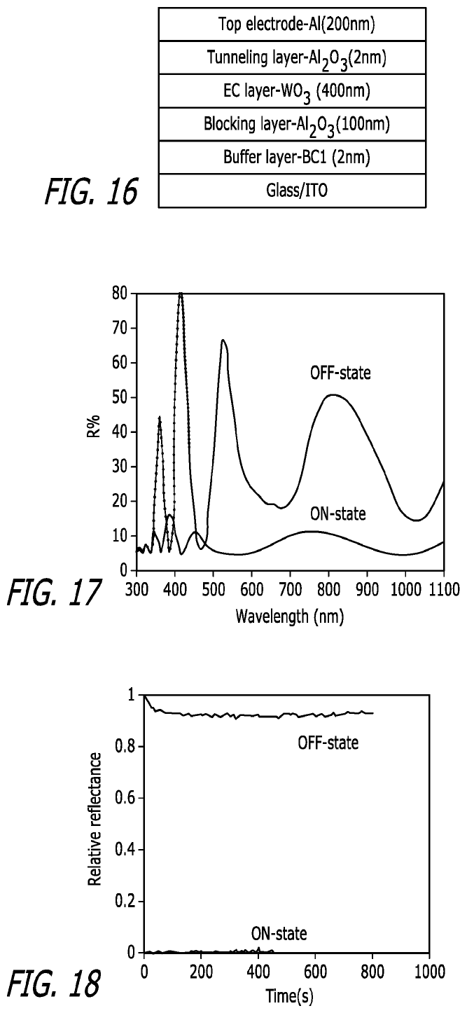

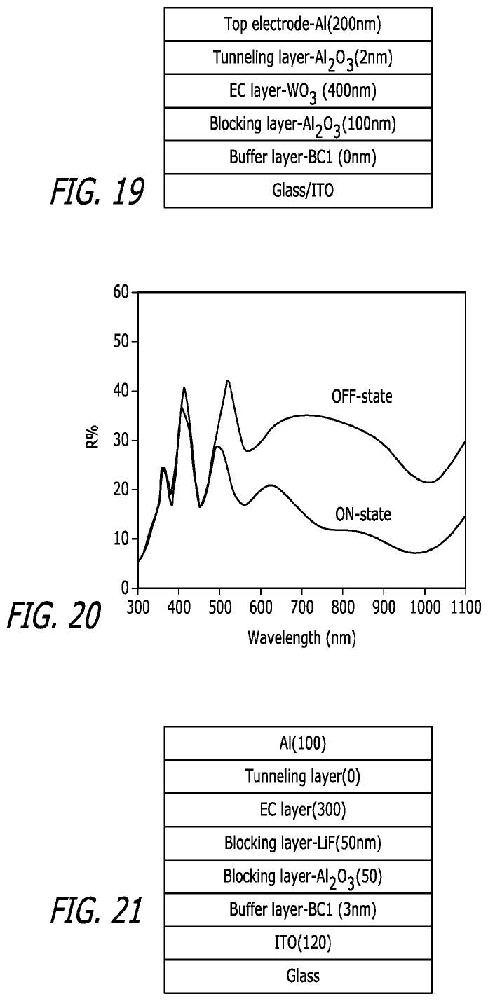

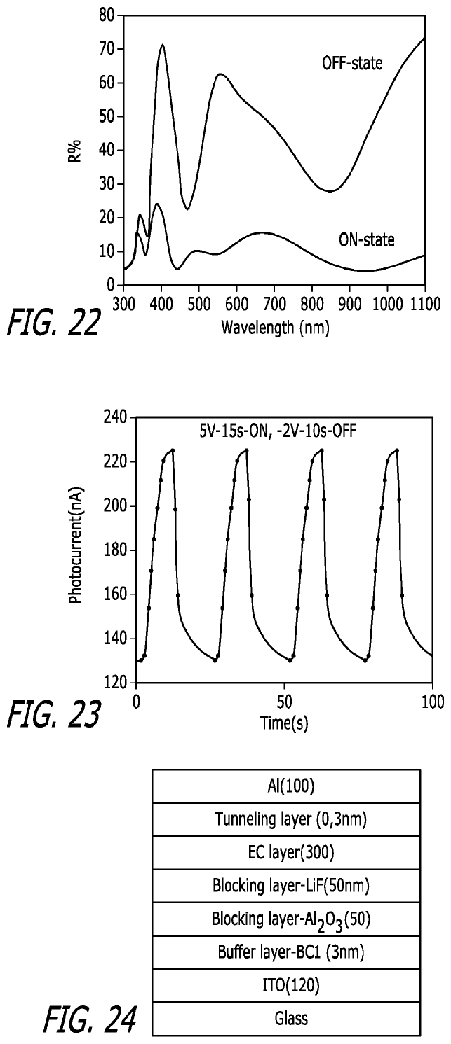

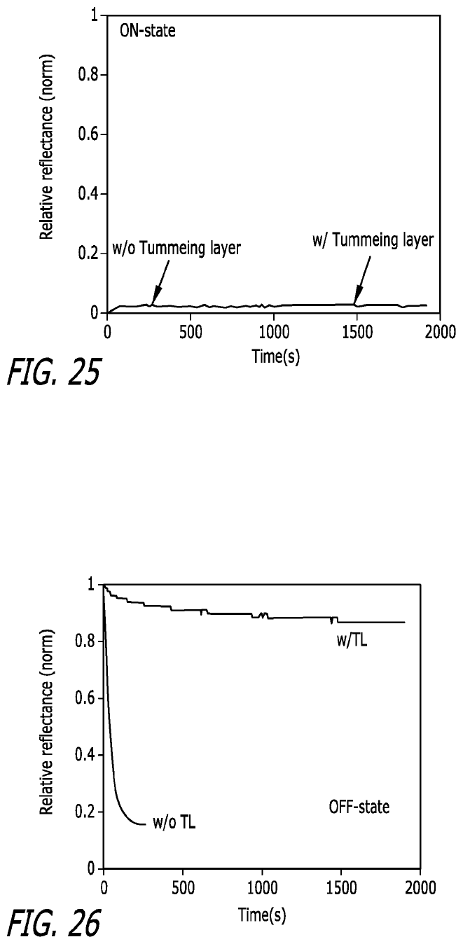

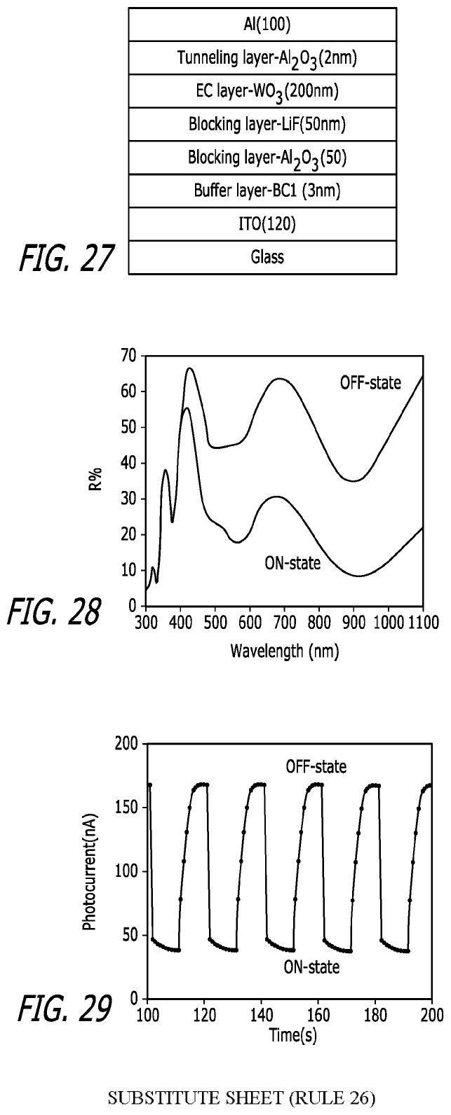

In addition, with the element inserted into the configuration described above, a DC pulse of −4 volts was applied to the Example EC-1 device for 2 seconds (time 0) and then +4 volts) was applied for 5 seconds, 5 minutes after the negative pulse was applied. After a five minute wait, this process was repeated. The results are illustrated in FIG. 12 from which it can be seen that both the OFF-state and On-state applications are stable without maintaining the application of power to the Example EC-1 device.

Similar testing was conducted for Examples EC1-B through EC1-G, EC-2A through EC-2E, and EC-3B through EC-3G. Various Figures are associated with these Examples and the results of the testing thereof, and Table 3 below identifies the Figures associated with each Example.

TABLE 3

| EXAMPLE | RELATED FIGURES |
|---|---|
| EC1-B | 13-15 |
| EC1-C | 16-18 |
| EC1-D | 19-20 |
| EC1-E | 21-23 |
| EC1-F | 24-26 |
| EC1-G | 27-29 |
| EC-2A | 30-31 |
| EC-2B | 32-33 |
| EC-2C | 34-35 |
| EC-2D | 36-37 |
| EC-2E | 38-40 |
| EC-3B | 41-43 |
| EC-3C | 44-46 |
| EC-3D | 47-48 |
| EC-3E | 49-51 |
| EC-3F | 52-54 |
| EC-3G | 55-57 |

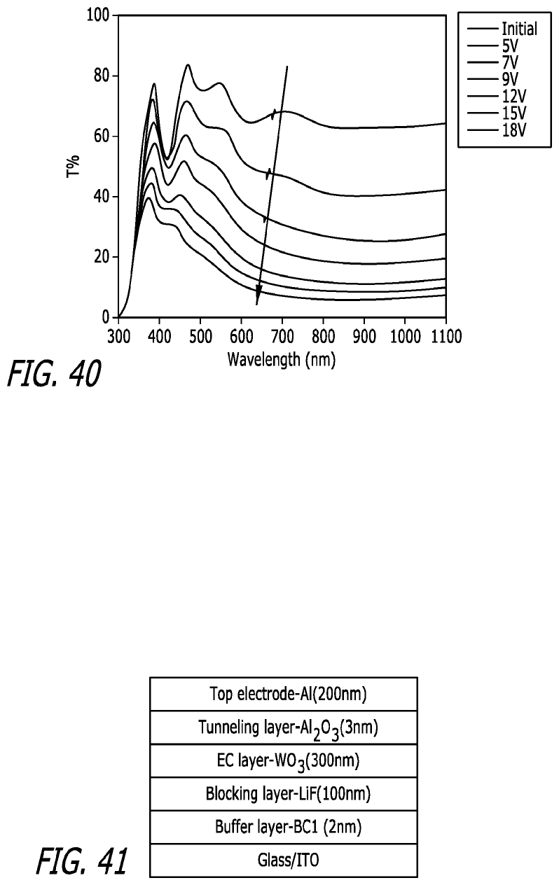

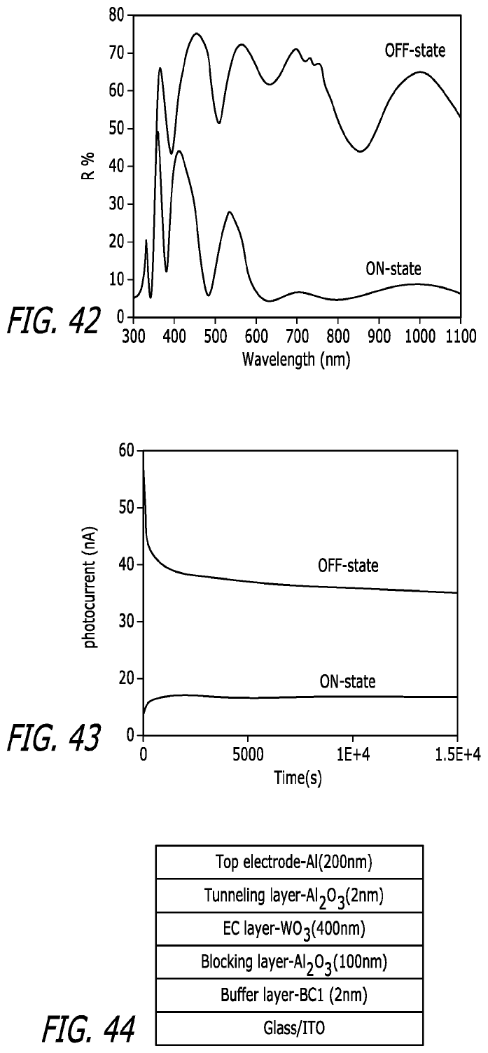

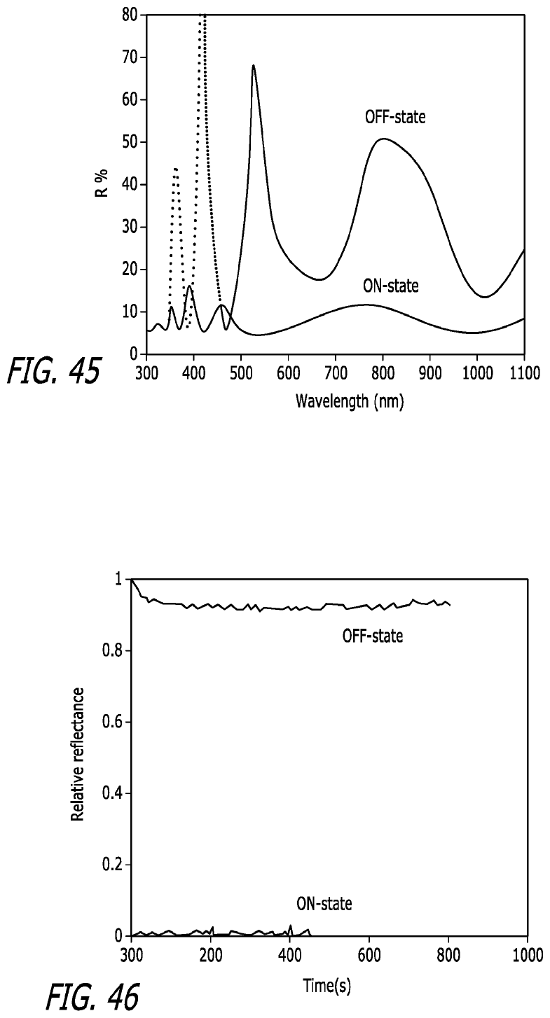

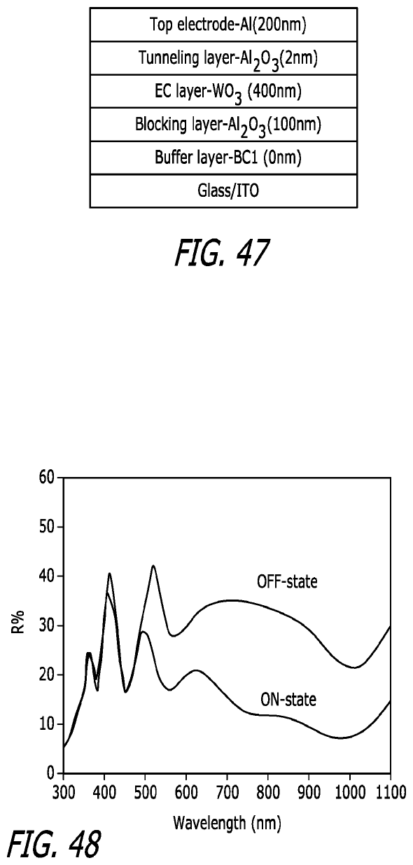

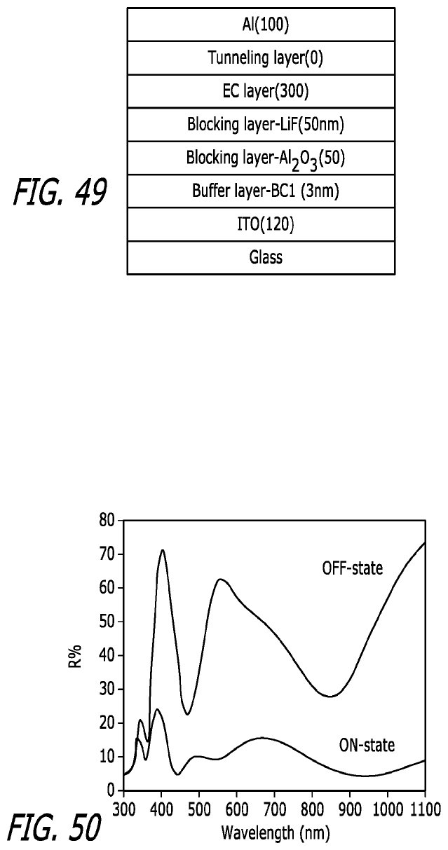

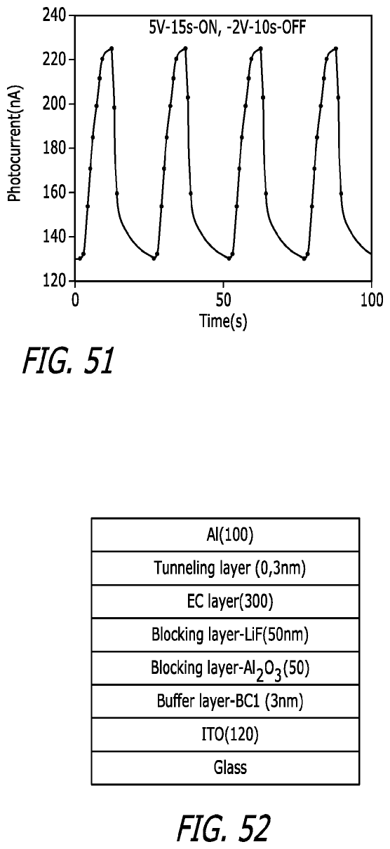

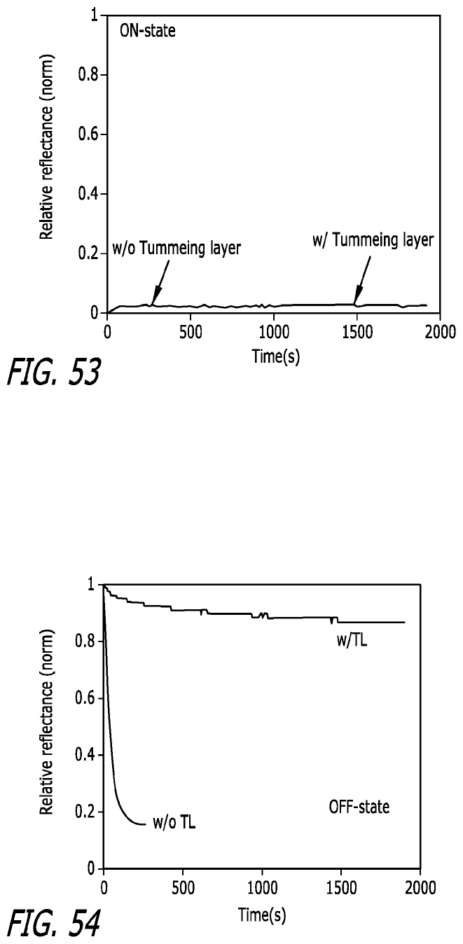

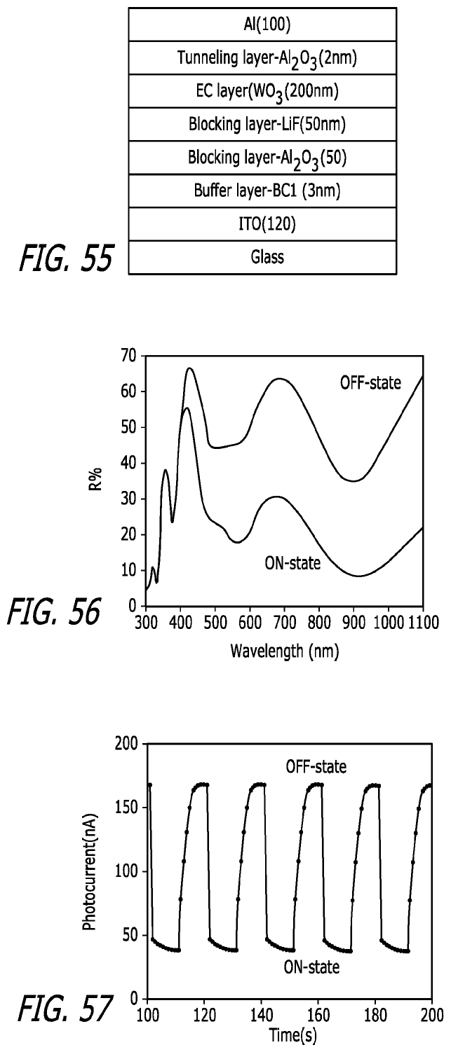

It is noted that FIGS. 30-40 are related to Examples EC-2A through EC-2E where an Al electrode grid instead of an Al sheet or reflective electrode material was present. These Examples also exhibit the stability and/or functioning of the devices discussed above. For example, Example EC-2B demonstrated a transmittance modulation (T %) of about 84.7% with less wavelength dependence (close to a neutral color); Example EC-2D showed a transmittance modulation of about 63.0%; Example EC-2C showed that the device had more than 100 cm²/C coloration efficiency at wavelengths above 600 nm; Example EC-3C showed both OFF-state and ON-state were quite stable without power (retention time); and Example EC-2E (FIG. 39) exhibited a retention time in the ON-state of about 1 month and/or was increasingly dimmable between about 5 volts to about 18 volts (FIG. 40).

For the processes and/or methods disclosed, the functions performed in the processes and methods may be implemented in differing order, as may be indicated by context. Furthermore, the outlined steps and operations are only provided as examples, and some of the steps and operations may be optional, combined into fewer steps and operations, or expanded into additional steps and operations.

This disclosure may sometimes illustrate different components contained within, or connected with, different other components. Such depicted architectures are merely exemplary, and many other architectures can be implemented which achieve the same or similar functionality.

The terms used in this disclosure, and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.). In addition, if a specific number of elements is introduced, this may be interpreted to mean at least the recited number, as may be indicated by context (e.g., the bare recitation of “two recitations,” without other modifiers, means at least two recitations, or two or more recitations). As used in this disclosure, any disjunctive word and/or phrase presenting two or more alternative terms should be understood to contemplate the possibilities of including one of the terms, either of the terms, or both terms. For example, the phrase “A or B” will be understood to include the possibilities of “A” or “B” or “A and B.”

The terms and words used are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

1. An electrochromic device, comprising a first layer including at least one electrode, a second layer providing a tunneling dielectric channel, a third layer including an electrochromic material, an electrically insulative fourth layer, and a fifth layer including at least one electrode.

2. The device of claim 1, wherein one or more optical properties of the electrochromic material are changeable upon application of an electric potential.

3. The device of claim 1, wherein the at least one electrode of the first layer is in electrical communication with the second layer, the second layer is in electrical communication with the third layer, the third layer is in electrical communication with the fourth layer, and the fourth layer is in electrical communication with the at least one electrode of the fifth layer.

4. The device of claim 1, wherein the first layer includes two electrodes.

5. The device of claim 1, wherein the first layer is positioned on a transparent substrate.

6. The device of claim 1, wherein the second layer includes an electrically insulative material.

7. The device of claim 6, wherein the electrically insulative material is an oxide or a nitride compound.

8. The device of claim 1, wherein the second layer is operable to pass electrons to or from the electrochromic material of the third layer upon application of an electric potential above a threshold where electron tunneling may occur in the second layer.

9. The device of claim 1, wherein the fourth layer includes an oxide compound, nitride compound, fluoride compound, or mixture thereof.

10. The device of claim 1, wherein the fourth layer provides an insulative effect which is greater than an insulative effect provided by the second layer.

11. The device of claim 1, wherein the electrochromic material is an anodic material.

12. The device of any one of claim 1, wherein the electrochromic material is a cathodic material.

13. The device of claim 1, wherein the electrodes are formed of a transparent material.

14. The device of claim 13, wherein the transparent material is a conductive oxide.

15. The device of claim 1, further comprising a frame supporting the first, second, third, fourth, and fifth layers.

16. A system, comprising an electrochromic device including an electrochromic material, wherein at least one optical property of the electrochromic material may be changed from a first state to a second state upon application of an electric potential, and wherein the device is structured to maintain the at least one optical property of the electrochromic material in the second state without continued application of the electric potential.

17. The system of claim 16, further comprising a power source structured to provide the electric potential to the electrochromic device.

18. The system of claim 17, wherein the electrochromic device includes a tunneling dielectric channel layer adjacent to a first side of the electrochromic material and an electrically insulative layer adjacent to an opposite, second side of the electrochromic material, and wherein the tunneling dielectric channel layer includes an electrically insulative material.

19. The system of claim 18, further comprising at least one electrode adjacent to the tunneling dielectric channel layer and at least one electrode adjacent to the electrically insulative layer.

20. A method for operating an electrochromic device including an electrochromic material, comprising supplying an electric potential to the device to change at least one optical property of the electrochromic material from a first state to a second state and discontinuing supply of the electric potential while maintaining the at least one optical property of the electrochromic material in the second state.

21.-23. (canceled)
